(19) United States
(12) Patent Application Publication
(10) Pub. No.: US 2012/0008248 A1
(43) Pub. Date: Jan. 12, 2012

(54) ISOLATOR HAVING TAPERED SIDEWALLS

(75) Inventors: Brian D. Sawyer, Palo Alto, CA (US); Christopher Hizer, Campbell, CA (US)

(73) Assignee: Ventiva, Inc., Santa Clara, CA (US)

(21) Appl. No.: 13/114,453

(22) Filed: May 24, 2011

Related U.S. Application Data
(60) Provisional application No. 61/362,977, filed on Jul. 9, 2010.

(51) Int. Cl. H01T 23/00

(52) U.S. Cl. 361/230

(57) ABSTRACT

An ion wind fan can be made more resistant to electrical arcing by designing a supporting dielectric further from an emitter electrode. In one embodiment, such an ion wind fan according to one embodiment of the present invention has an emitter electrode and a collector electrode, and an isolator comprising a dielectric to provide electrical isolation for one or both of the emitter electrode and the collector electrode. In one embodiment, the isolator has a tapered sidewall so that the sidewall becomes thinner in the upstream direction over at least a portion of the sidewall. In one embodiment, the taper is a linear taper.

### CROSS-REFERENCE TO RELATED APPLICATIONS

This Application claims the priority benefit of U.S. Provisional Patent Application 61/362,977 entitled “Ion Wind Fan Designs,” filed on Jul. 9, 2010, which is hereby fully incorporated by reference.

### FIELD OF THE INVENTION

The embodiments of the present invention are related to ion wind fans.

### BACKGROUND

It is well known that heat can be a problem in many electronics device environments, and that overheating can lead to failure of components such as integrated circuits (e.g. a central processing unit (CPU) of a computer) and other electronic components. Most electronics devices, from LED lighting to computers and entertainment devices, implements some form of thermal management to remove excess heat.

Heat sinks are a common passive tool used for thermal management. Heat sinks use conduction and convection to dissipate heat and thermally manage the heat-producing component. To increase the heat dissipation of a heat sink, a conventional rotary fan or blower fan has been used to move air across the surface of the heat sink, referred to generally as forced convection. Conventional fans have many disadvantages when used in consumer electronics products, such as noise, weight, size, and reliability caused by the failure of moving parts and bearings.

A solid-state fan using ionic wind to move air addresses the disadvantages of conventional fans. However, providing an ion wind fan that meets the requirements of consumer electronics devices presents numerous challenges not addressed by any currently existing ionic wind device.

### BRIEF DESCRIPTION OF THE DRAWINGS

FIG. 1 is a block diagram illustrating an ion wind fan implemented as part of thermal management of an electronic device;

FIG. 2A is a perspective view of an ion wind fan according to one embodiment of the present invention;

FIG. 2B is a widthwise cross-sectional view of the ion wind fan of FIG. 2A according to one embodiment of the present invention

FIG. 3A is an upstream elevation view of an ion wind fan according to one embodiment of the present invention;

FIG. 3B is a downstream elevation view of the ion wind fan of FIG. 3A according to one embodiment of the present invention;

FIG. 3C is a side elevation view of the ion wind fan of FIG. 3A according to one embodiment of the present invention;

FIG. 3D is a downstream perspective view of the ion wind fan of FIG. 3A according to one embodiment of the present invention;

FIG. 3E is an upstream perspective view of the ion wind fan of FIG. 3A according to one embodiment of the present invention;

FIG. 4A is a cross-sectional view of an isolator of the ion wind fan of FIG. 3A according to one embodiment of the present invention; and

FIG. 4B is a cross-sectional view of the ion wind fan of FIG. 3A according to one embodiment of the present invention.

### DETAILED DESCRIPTION

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not necessarily be so limited; rather the principles thereof can be extended to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

Ion wind or corona wind generally refers to the gas flow that is established between two electrodes, one sharp and the other blunt, when a high voltage is applied between the electrodes. The air is partially ionized in the region of high electric field near the sharp electrode. The ions that are attracted to the more distant blunt electrode collide with neutral (uncharged) molecules en route to the collector electrode and create a pumping action resulting in air movement. The high voltage sharp electrode is generally referred to as the emitter electrode or corona electrode, and the grounded blunt electrode is generally referred to as the counter electrode, getter electrode, or collector electrode.

The general concept of ion wind—also sometimes referred to as ionic wind and corona wind even though these concepts are not entirely synonymous—has been known for some time. For example, U.S. Pat. No. 4,210,847 to Shannon, et al., dated Jul. 1, 1980, titled “Electric Wind Generator” describes a corona wind device using a needle as the sharp corona electrode and a mesh screen as the blunt collector electrode. The concept of ion wind has been implemented in relatively large-scale air filtration devices, such as the Sharper Image Ionic Breeze.

### Example Ion Wind Fan Thermal Management Solution

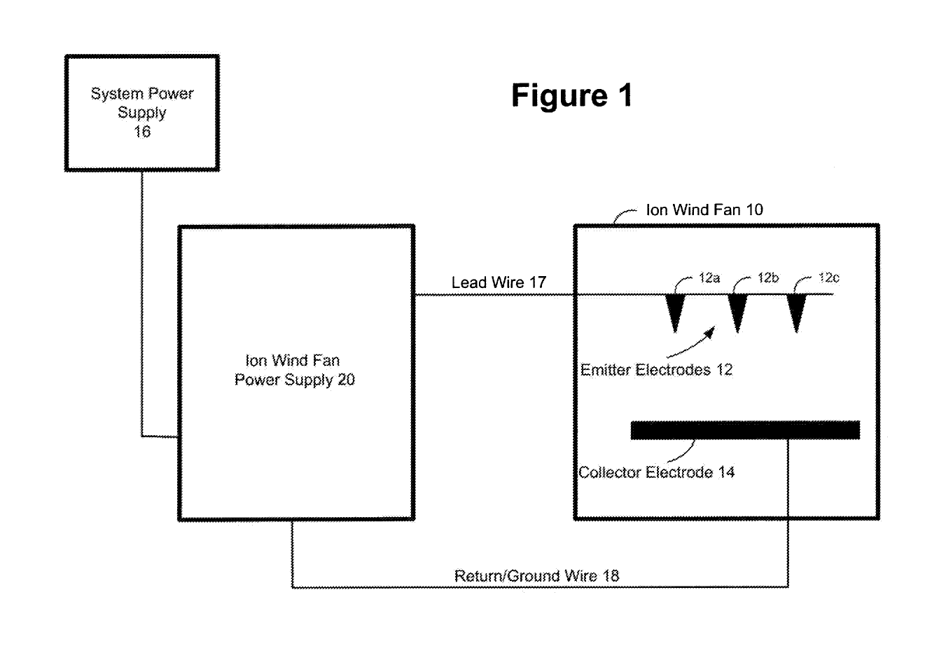

FIG. 1 illustrates an ion wind fan 10 used as part of a thermal management solution for an electronic device. As used in this Application, the descriptive term “ion wind fan,” is used to refer to any electro-aerodynamic pump, electro-hydrodynamic (EHD) pump, EHD thruster, corona wind device, ionic wind device, or any other such device used to move air or other gas. The term “fan” refers to any device that move air or some other gas. The term ion wind fan is meant to distinguish the fan from conventional rotary and blower fans. However, any type of ionic gas movement can be used in an ion wind fan, including, but not limited to corona discharge, dielectric barrier discharge, or any other ion generating technique.

An electronic device may need thermal management for an integrated circuit—such as a chip or a processor—that produces heat, or some other heat source, such as a light emitting diode (LED). Some example systems that can use an ion wind fan for thermal management include computers, laptops, gaming devices, projectors, television sets, set-top boxes, servers, NAS devices, memory devices, LED lighting devices, LED display devices, smart-phones, music players and other mobile devices, and generally any device having a heat source requiring thermal management.

The electronic device can have a system power supply 16 or can receive power directly from the mains AC via a wall outlet, Edison socket, or other outlet type. For example, in the case of a laptop computer, the laptop will have a system power supply such as a battery that provides electric power to the electronic components of the laptop. In the case of a wall-plug device such as a gaming device, television set, or LED lighting solution (lamp or bulb), the system power supply 16 will receive the 110V mains AC (in the U.S.A, 220V in the EU) current from an electrical outlet or socket.

The system power supply 16 for such a plug or screw-in device will also convert the mains AC into the appropriate voltage and type of current needed by the device (e.g., 20-50V DC for an LED lamp). While the system power supply 16 is shown as separate from the IWFPS 20, in some embodiments, one power supply can provide the appropriate voltage to both an ion wind fan 10 and other components of the electronic device. For example, a single driver can be design to drive the LEDs of and LED lamp and an ion wind fan included in the LED lamp.

The electronic device also includes a heat source (not shown), and may also include a passive thermal management element, such as a heat sink (also not shown). To assist in heat transfer, an ion wind fan 10 is provided in the system to help move air across the surface of the heat source or the heat sink, or just to generally circulate air (or some other gas) inside the device. In prior art systems, conventional rotary fans with rotating fan blades have been used for this purpose.

As discussed above, the ion wind fan 10 operates by creating a high electric field around one or more emitter electrodes 12 resulting in the generation of ions, which are then attracted to a collector electrode 14. In FIG. 1, the emitter electrodes 12 are represented as triangles as an illustration that they are generally “sharp” electrodes. However, in a real-world ion wind fan 10, the emitter electrodes 12 can be implemented as wires, shims, blades, pins, and numerous other geometries. Furthermore, while the ion wind fan 10 in FIG. 1 has three emitter electrodes (12a, 12b, 12c), the various embodiments of the present invention described herein can be implemented in conjunction with ion wind fans having any number of emitter electrodes 12.

Similarly, the collector electrode 14 is shown simply as a plate in FIG. 1. However, a real-world collector electrode 14 can have various shapes and will generally include openings to allow the passage of air. The collector electrode 14 can also be implemented as multiple collector electrode members (e.g., rods, washers) held at substantially the same potential. Furthermore, in a real world ion wind fan 10, the emitter electrodes 12 and the collector electrode 14 would be disposed on a dielectric chassis—sometimes referred to as an isolator element—that has also been omitted from FIG. 1 for simplicity and ease of understanding.

To create the high electric field necessary for ion generation, the ion wind fan 10 is connected to an ion wind power supply 20. The ion wind power supply 20 is a high-voltage power supply that can apply a high voltage potential across the emitter electrodes 12 and the collector electrode 14. The ion wind fan power supply 20 (hereinafter sometimes referred to as “IWFPS”) is electrically coupled to and receives electrical power from the system power supply 16. Usually for electronic devices, the system power supply 16 provides low-voltage direct current (DC) power. For example, a laptop computer system power supply would likely output approximately 5-12V DC, while the power supply for an LED light fixture would likely output approximately 20-70V DC.

The high voltage DC generated by the IWFPS 20 is then electrically coupled to the emitter electrodes 12 of the ion wind fan 10 via a lead wire 17. The collector electrode 14 is connected back to the IWFPS 20 via return/ground wire 18, to ground the collector electrode 14 thereby creating a high voltage potential across the emitters 12 and the collector 14 electrodes. The return wire 18 can be connected to a system, local, or absolute high-voltage ground using conventional techniques.

While the system shown in and described with reference to FIG. 1 uses a positive DC voltage to generate ions, ion wind can be created using AC voltage, or by connecting the emitters 12 to the negative terminal of the IWFPS 20 resulting in a “negative” corona wind. Embodiments of the present invention are not limited to positive DC voltage ion wind. Furthermore, while the IWFPS 20 is shown to receive power from a system power supply 30, in other embodiment, the IWFPS 20 can receive power directly from an outlet.

The IWFPS 20 may include other components. Furthermore, in some embodiments, some of the components listed above may be omitted or replaced by similar or equivalent circuits. For example, the IWFPS 20 is described only as an example. Many different kinds and types of power supplies can be used as the IWFPS 20, including power supplies that do not have a transformers or other components shown in FIG. 1. The components described need not be physically separate, and may be combined on a single printed circuit board (PCB).

### Example Ion Wind Fan

As described partially above, ion wind is generated by the ion wind fan 10 by applying a high voltage potential across the emitter 12 and collector 14 electrodes. This creates a strong electric field around the emitter electrodes 12, strong enough to ionize the air in the vicinity of the emitter electrodes 12, in effect creating a plasma region. The ions are attracted to collector electrode 12, and as they move in air gap along the electric field lines, the ions bump into neutral air molecules, creating airflow. On a real world collector electrode 14, air passage openings (not shown) allow the airflow to pass through the collector 14 thus creating an ion wind fan.

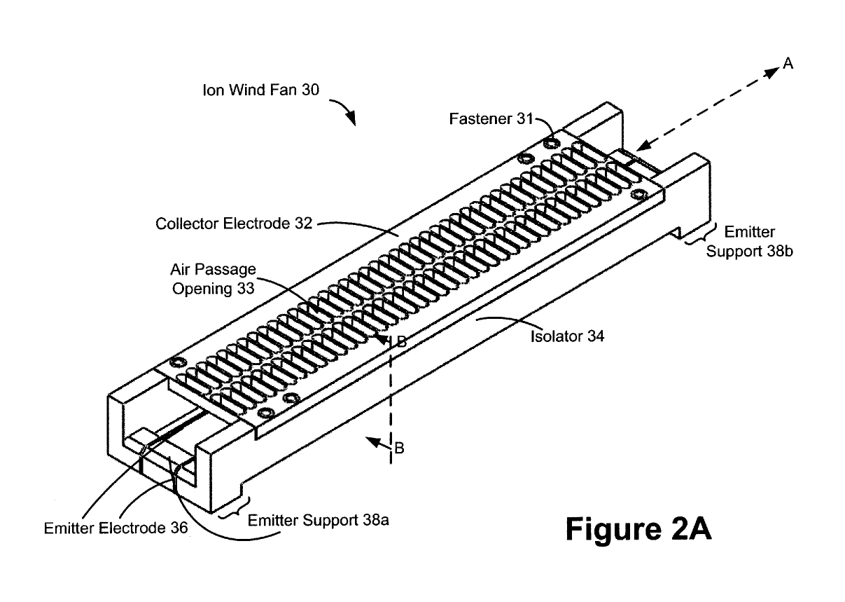

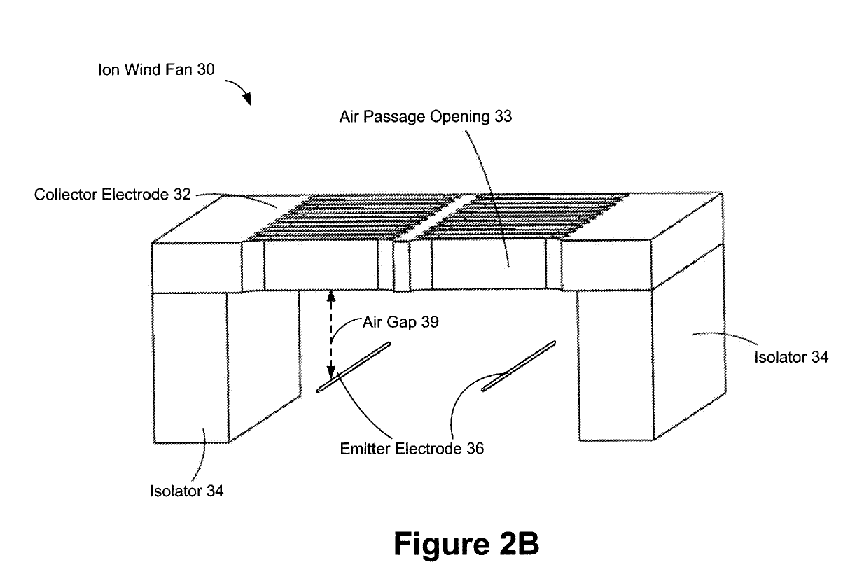

A previous ion wind fan design by the applicants of the present Application is now described with reference to FIGS. 2A and 2B for reference and comparison. FIG. 2A is a perspective view of an example ion wind fan 30. The ion wind fan 30 includes a collector electrode 32 having air passage openings 33 to allow airflow. This example ion wind fan 30 has two emitter electrodes 36 implemented as wires, thus implementing what is sometimes referred to as a “wire-to-plane” configuration.

The collector electrode 32 and the emitter electrodes 36 are both supported by an isolator 34. The isolator is made of a dielectric material, such as plastic, ceramic, and the like. The “isolator” component is thusly named as it functions to electrically isolate the emitter electrodes 36 from the collector electrode 32, and to physically support these electrodes. As such the isolator also can establish the spatial relationship between the electrodes, sometimes referred to under the rubric of electrode geometry. The isolator 34 can be made from one integral piece—as shown in FIG. 2A—or it can be made of multiple parts and pieces.

In the embodiment shown in FIG. 2A, the collector electrode is attached to the isolator using a fastener 31. The fastener 31 in FIG. 2 is a stake, but any other attachment method can be used, including but not limited to screws, hooks, glue, and so on. Similarly, the particular method of attachment of the emitter electrodes 36 is not essential to the embodiments of the present invention. The emitter electrodes 36 can be glued, staked, screwed, tied, held by friction, or attached in any other way to the isolator 34.

The ion wind fan 30—in the embodiment shown in FIG. 2A—is substantially rectangular in top view. The longitudinal axis of the ion wind fan 30 is denoted with the dotted arrow labeled “A.” The ion wind fan 30 has two ends opposite each other along the longitudinal axis. The emitter electrodes 36 are suspended between the two ends of the ion wind fan 30.

In one embodiment, the emitter electrodes 36 are supported at the ends of the ion wind fan 30 by an emitter support 38 portion of the isolator 34. The emitter support 38a at the left end of the ion wind fan 30 is most visible in FIG. 2A. The emitter support 38a is a portion of the isolator that physically supports the emitter electrodes 36. In one embodiment, the emitter electrodes 36 are suspended (in tension) between the two emitter supports 38 at the two ends of the ion wind fan 30.

In the embodiment shown in FIG. 2A, the isolator 34 has two elongated members oriented along the longitudinal direction that support the collector electrode 32, and the two elongated members (also referred to as sidewalls) are held joined by two cross-members that support the emitter electrodes 36. In one embodiment, these cross-members are oriented perpendicular to the elongated members (and thus the longitudinal axis). In FIG. 2A, these cross-members make up the emitter supports 38.

Thus, while in one embodiment the emitter support 38a is a substantially rectangular solid portion of the isolator 34 that connects the two elongated side portions of the isolator 34, in other embodiments the emitter supports 38 can have many other shapes and orientations. For example, a part of the center portion of the emitter support 38a between the emitter electrodes 36 could be cut away without substantially affecting the function of the emitter support 38a.

The emitter support 38a is shown as extending to the end of the ion wind fan 30. However, in other embodiments, the emitter support 38a can end before the end of the ion wind fan 30. The emitter support 38a is also shown as having a curved section at its outside edge to smooth out the 90 degree bend in the wire emitter electrodes 36. This is an optional feature not related to the embodiments of the present invention described herein.

Indeed, the actual attachment of the emitter electrodes 36 to either the emitter support 38 or some other portion of the isolator 34 is not material to the embodiments of the present invention, and therefore will not be discussed in much detail for simplicity and ease of understanding. The emitter electrodes 36 are shown as extending downward from the left end of the ion wind fan 30 and they are connected to the power supply via some wire or bus, as is the collector electrode 32. The emitter supports 38 need not have any particular shape of contact with the emitter electrodes 36. The emitter supports 38 are the portions of the isolator 34 that define the physical spatial relationship between the emitter electrodes 34 and other components of the ion wind fan 30. How exactly the emitter supports 38 are in contact with the emitter electrodes 36 (grooves, stakes, friction, posts, welding, epoxy) are not germane to the embodiments of the present invention.

FIG. 2B further illustrates the example ion wind fan 30 shown in FIG. 2A. FIG. 2B is a perspective cross sectional view of the ion wind fan 30 along the line B-B shown in FIG. 2A. The emitter electrodes 36 are suspended in air, and held a substantially constant air gap 39 distance away from the collector electrode 32.

Though wire sag and other emitter irregularities will create some variance, in one embodiment the air gap 39 between the emitter electrodes 36 and the bottom plane of the collector electrode 32 is substantially constant (within a 5% variation). In other embodiments, the air gap 39 can be more variable. The size of the air gap 39 is dependent on the spatial relationship between the electrodes established by the emitter supports 38 (which are not visible in FIG. 2B).

### Tapered Isolators

As explained above, the size of the ion wind fans being developed by the inventors is significantly smaller that the ionic wind applications of the prior art. This small size and small air gap between the emitter and collector electrodes makes certain designs advantageous that are not necessarily so for larger scale ionic air pumps. One such feature is an isolator having a tapered design, one embodiment of which is described below.

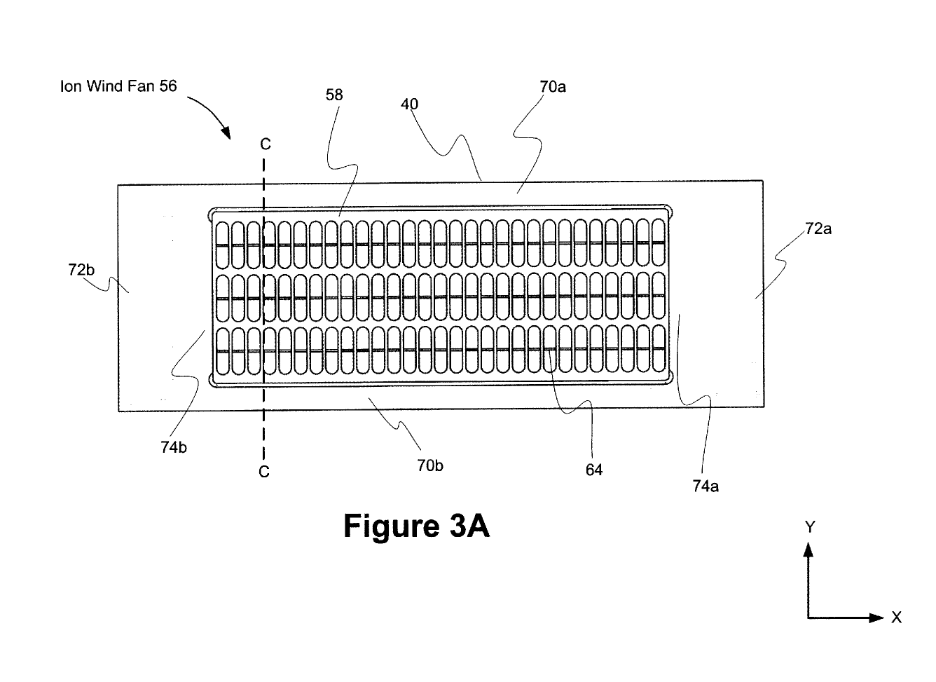

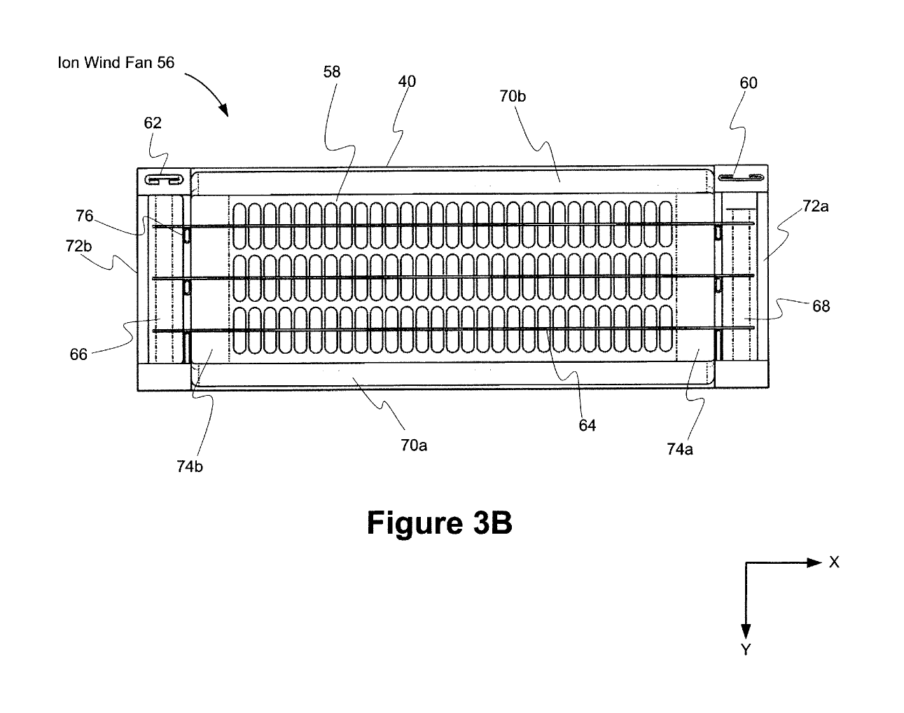

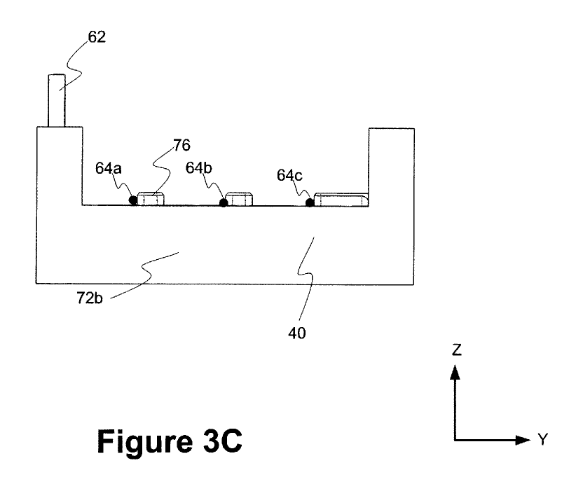

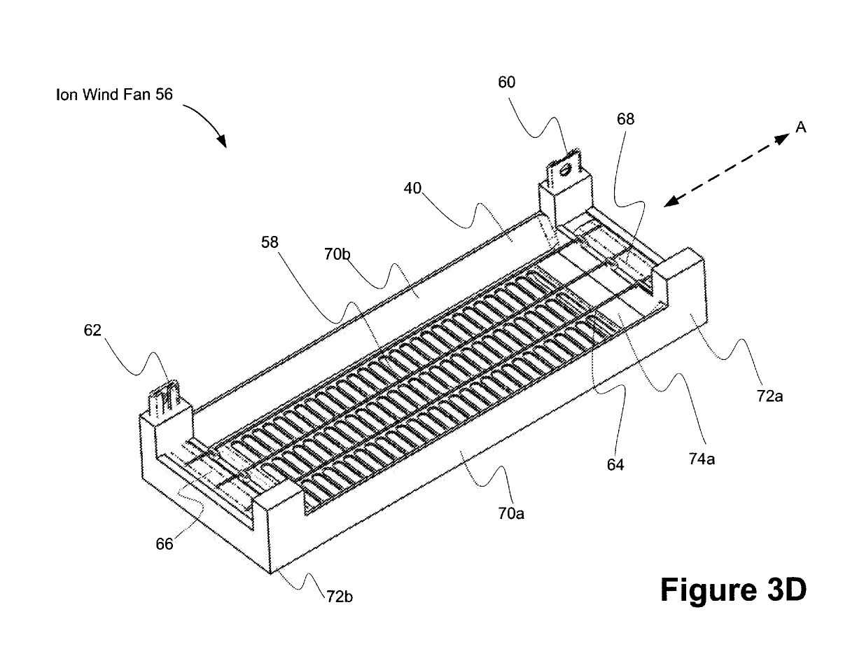

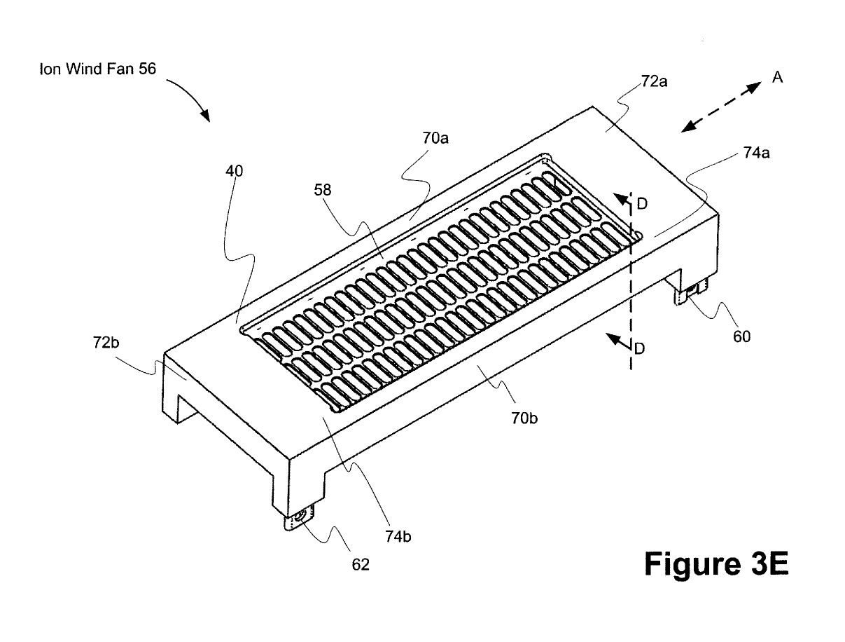

FIG. 3A is an “upstream” elevation view of an ion wind fan 56, so that the viewer is looking upstream and the wind from fan 56 would be blowing towards the viewer when in operation. From this view, the ion wind fan 56 of FIG. 3 is substantially similar to the ion wind fan 30 of FIG. 2. In this embodiment, the collector 58 is insert-molded into the isolator 40. The collector 38 is still substantially plane-like with air-passage openings, and the isolator 40 has a frame-like shape. The ion wind fan 56 is shown so that the X-axis corresponds with the longitudinal axis of the fan 56 and the Y-axis corresponds with the width direction of the fan 56. The unseen Z-axis corresponds with the depth of the fan 56.

The isolator 40 has two ends 72 longitudinally opposite each other, that also defined the end of the fan 56. The isolator ends 72 are also the widthwise sides of the isolator frame and include the emitter supports and attachments on their upstream sides. The emitter electrodes 64 are visible through the air-passage openings of the collector electrode 58. In the embodiment shown, from each isolator end portion 72 protrudes a collector support 74 into which the collector is insert-molded.

The sidewalls 70 or the isolator make up the long sides of the isolator's 40 frame-like rectangle, although in other embodiments they can be the short sides. In the case of wire emitter electrodes (such as in FIG. 3), the sidewalls are generally those portions of the isolator 40 that are oriented along the same general axis as the emitter wires (e.g., the X-axis in FIG. 3A).

FIG. 3B is a downstream elevation view of the ion wind fan 56, so that the airflow generated would blow away from the viewer along the Z-axis. The emitter electrodes 64, in this embodiment, are attached to plates 66, 68 on respective ends 72b, 72a or the ion wind fan 56. The bus plate 66 is electrically connected to the emitter prong 62 (for example by the bus plate 66 and the emitter prong 62 being formed from one piece of metal or other conductor), and is used to energize the emitter electrodes 64.

The attachment plate 68 is used to attach the emitter electrodes, in one embodiment, to the ion wind fan 56 at the opposite end 72a from the bus plate 66. The collector electrode 58 is electrically connected to the collector prong 60 used to ground, energize, or otherwise connect the collector electrode 58 to the power supply. The collector 58 and the collector prong 60 can be formed from one piece of metal or other conductor.

In one embodiment, in addition to being insert-molded into the sidewalls 70 of the isolator, the emitter electrode is also supported by the collector supports 74 that protrude from the fan end portions 72. In addition to providing support, the collector supports 74 prevent air recirculation by blocking airflow in areas not covered by the collector 58, as can also be seen in FIG. 3A.

In one embodiment, alignment posts 76 aid is the positioning of the emitter electrodes 64 during manufacturing. In one embodiment, the end portions 72, the sidewalls 70, the collector supports 74, and the alignment posts 76 are all parts of the isolator 40. The isolator 40 is made of a dielectric material, such as plastic, and can be formed in one single shot of injection molding.

Thus, all portions and pieces of the isolator are formed, in one embodiment, as one integral piece of dielectric material. In one embodiment, the dielectric material of which the isolator 40 is made is liquid-crystal polymer (LCP). LCPs are generally rigid, durable, and have desirable thermal properties that make them well-suited for providing isolation for an ion wind fan used for thermal management.

FIG. 3C is a side elevation view of the ion wind fan 56 sighting down the longitudinal X-axis from the side of the fan 56 having end portion 72b. The three emitter electrodes 64a,b,c are visible at their end, as well as the alignment posts 76. The airflow would substantially be in the negative Z-axis direction.

FIG. 3D is a perspective “downstream” view of the ion wind fan 56, so that the direction of the airflow is still towards the bottom of the page, as in FIG. 3C. The longitudinal axis (labeled “A”) of the ion wind fan 56 is shown, which is parallel to the X-axis of FIGS. 3A-C. In one embodiment, as can be seen in FIG. 3D, the sidewall 70b is tapered so that the sidewall is thicker in the Y-direction at the front of the fan 56 (closer to the collector 58 in the Z-direction) than it is at the bottom of the fan 56 (closer to the emitters 64 in the Z-direction). In the embodiment shown, the angle of the taper is about 30 degrees, but other taper degrees between 15-75 degrees can be used.

In one embodiment, the collector electrode 58 is stamped metal, and may or may not have some coating or plating on top of the base metal. In the embodiment shown, the collector electrode 58 is mostly flat with rows of ovalized/rounded rectangular air passage openings, each row being oriented parallel to the longitudinal axis “A,” which is also the orientation of the emitter electrodes (parallel to the X-axis).

The emitter electrodes 65, in one embodiment, are bused together and the bus is connected to or includes an emitter prong 62 that protrudes from the isolator 40. In the embodiment shown, the emitter prong 62 protrudes from the isolator in a direction (the Z-direction) perpendicular to the orientation of the collector electrode 58, the emitter electrodes and the longitudinal axis. However, in other embodiments, the emitter prong 62 can protrude in other directions. In one embodiment, power is supplied to the emitter electrodes 64 by connecting the emitter prong 62 to the high voltage ion wind fan power supply.

Similarly, the collector prong 60 connects the collector electrode 58 to the power supply, or to a ground. The collector prong 60 can protrude in other directions as well. In the embodiment shown, the collector prong 60 is located at the longitudinally opposite end of the ion wind fan 56 where the emitter prong 62 is located. In other embodiments, the collector prong 60 can be located on the same end of the ion wind fan 56 as the emitter prong 62.

In one embodiment, the emitter bus plate 66 and the emitter prong 62 are made of one metallic piece that is bent into an L-like shape and insert-molded into the isolator 40. In other embodiments other attachment methods can be used, such as glue and epoxy, and the emitter bus plate 66 can be made of a separate component from the emitter prong 62, which can be electrically coupled to the emitter bus plate 66.

The collector prong 60 shown in FIG. 3D can be a portion of the collector electrode 58 that is bent and insert-molded into the isolator 40 along with the collector electrode 58 with which it forms one integral piece of metal. In other embodiments, the collector electrode 58 and the collector prong 60 are separate components that are electrically coupled.

FIG. 3E is a perspective upstream view of the ion wind fan 56 showing all the elements previously numbered and described. Axis “A” once again represents the longitudinal axis of the fan 56. Various features on the upstream side of the ion wind fan 56, such as the emitter electrodes 64 are not visible in the view shown in FIG. 3E.

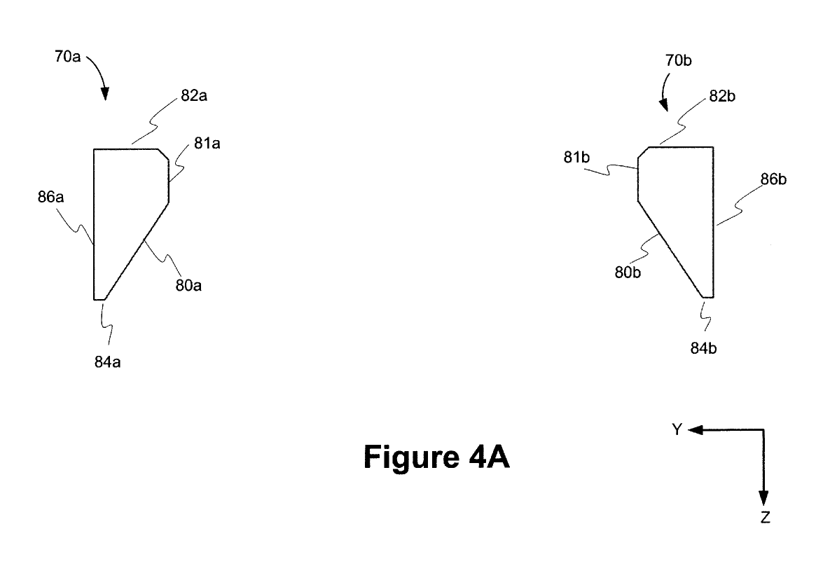

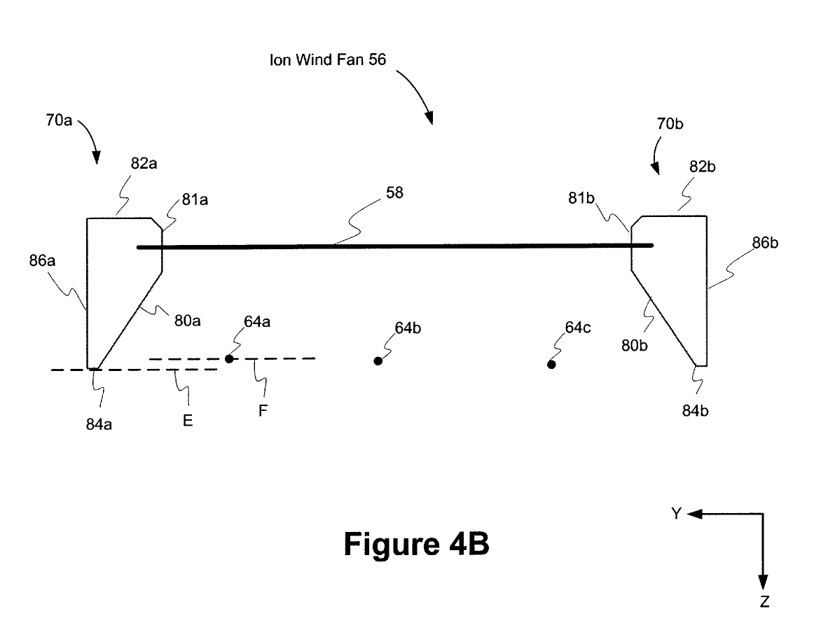

FIG. 4A and 4B are cross-sectional views of the isolator 40 and the ion wind fan 56 taken at either the line C-C in FIG. 3A or the line D-D in FIG. 3E. FIG. 4A showns only the sidewalls 70a,b of the isolator 40 for simplicity and ease of understanding, while FIG. 4B also shown the emitter 64 and collector 58 electrodes. As mentioned above, the intended direction of airflow is in the negative Z-direction (towards the top of the page).

In one embodiment, the sidewalls 70 are solid, although they can be hollow or include other features in other embodiments. In one embodiment, the cross-section of the sidewalls 70 is substantially constant for most of the length (in the X-direction) of the sidewalls 70, although other embodiments can have variable cross-sections.

In one embodiment, the surface of the left sidewall 70a includes an external sidewall portion 86a that defines the left side of the ion wind fan 56 in the Y-direction, which transitions into a downstream sidewall portion 82a (facing downstream defining the front/top of the ion wind fan 56), which transitions into an internal sidewall portion 81a (facing in opposite direction as the external sidewall portion 86a). In the embodiment shown, there is also a small chamfer portion between the downstream portion 82a and the internal portion 81a, though this design feature is optional and not related to the embodiments of the present inventions. There is also an upstream sidewall portion 84a facing upstream in the Z-direction and defining the back/bottom of the fan 56).

In one embodiment, joining the upstream sidewall portion 84a and the internal sidewall portion 81a is an internal tapered portion 80a. In one embodiment, the angle of taper of the tapered portion 80a is measured as the angle between the external sidewall portion 86a and the tapered portion 80a. In other embodiments, the angle of taper can be measured from the Z-axis, from the X-Z-plane, or from the direction is desired airflow.

In another embodiment, the cross-section of the sidewall 70a can be triangular, thus omitting the internal sidewall portion 81a and the upstream sidewall portion 84a. The tapered portion 80a would, in such an embodiment, be a bevel edge between the downstream potion 82a and the external portion 86a. In yet another embodiment, only the internal portion 81a can be eliminated, thus having the tapered portion form a chamfered edge between the downstream portion 82a and the upstream portion 84a.

In the embodiment shown, the sidewall 70a is oriented in the X-direction and linearly tapers in width (Y-direction) along the Z-axis over a portion of the sidewall 70a shown as the tapered portion 80a, getting less wide further upstream in the Z-direction. One purpose for the tapered portion (and thus the tapering of the sidewall) is to move the surface of the sidewall 70a further from the leftmost emitter electrode 64a then it would be without such a taper. In other words, if the sidewalls had rectangular cross-sections, the edge emitters 64a, 64c would be nearer the sidewalls than they are with the tapered sidewalls 70a, 70b shown in FIGS. 3 and 4.

While in FIGS. 3 and 4, the taper shown is a linear taper, other tapers can be used. As used in the present application, the tapering of the sidewalls 70 refers to the fact that the width (in the Y-direction) of the sidewalls is greater downstream than upstream. The tapered portion 80a shown is a linear taper as the tapered sidewall portion 80a is approximately plane-like. In FIG. 4A-B the sidewall portions 80-86 meet each other at sharp angles, but in other embodiments they can transition smoothly.

However, the sidewalls 70 can be tapered using curved surfaces. For example, the tapered portion 80a could be a concave surface formed of any regular (such as parabolic) curve or irregular curve. Convex surfaces can be used to taper the sidewalls 70 as well, although they are less desirable, as they create less additional distance between the emitter 64a and the sidewall 70a.

While any kind and degree of tapering can be used, in one embodiment, a design rule for the taper is that the surface path along the sidewall should be at least twice as long as the difference between the air gap between the emitter 64a and the collector 58 and the air gap between the emitter 64a and the sidewall 70a. The surface path along the sidewall is the path from a section of the tapered portion 80a that is nearest the left emitter 64a to the collector electrode 58 along the surface of the sidewall 70a.

In another embodiment, another function of the tapering of the sidewall 70 is to simultaneously have the sidewall be tall enough in the Z-direction to protect the emitter electrodes 64, the collector electrode 58, or both, while also being narrow enough (Y-axis) to create distance between the sidewalls 70 and the edge emitter electrodes 64a, 64c, and wide enough (Y-axis) to provide structural rigidity. Thus, in one embodiment, the height of the sidewall (Z-direction) is such that the sidewall 70a extends further in the Z-direction than the X-Y plane of the emitter electrodes 64. This is illustrated in FIG. 4B by the dotted line E (showing the X-Y plane of the upstream end of the ion wind fan 56) being below the dotted line F (representing the X-Y plane of the emitter electrodes 64).

In the embodiment shown in FIGS. 3 and 4, the height of the isolator sidewall 70a also extends above the plane of the collector electrode 58 in the downstream Z-direction. In such an embodiment, the sidewalls 70 further function to physically protect the collector electrode 58 from damage. In some embodiments, the collector electrode 58 is made of a thin piece of stamped metal that is insert-molded into the isolator 40. In such embodiments, the collector electrode 58 can be fragile and easily deformable by physical contact. Such deformation can alter the electrical properties of the ion wind fan 56. Thus protecting the thin wire emitters 64 and the thin collector electrode 58 can be an important function of the isolator 40 in general and the sidewalls 70 in particular.

One advantage of the tapered sidewall 70 is that the distance between the edge emitters 64a, 64c and the sidewalls 70 is increased without widening the ion wind fan 56, the isolator 40, or the collector electrode 58, thus enabling smaller form factors. Another benefit can be better and smoother airflow downstream in the Z-direction, as well as physical protection of the various electrodes.

While most of the discussion above was related to the left sidewall 70a of the isolator 40, the right sidewall 70b ca be implemented and designed in any of the ways described with reference to the left sidewall 70a. In some embodiments, such as the one shown in FIGS. 3-4, the right sidewall 70b is a mirror image of the left sidewall 70a. In other embodiments, the exterior surfaces of the sidewalls 70, such as external portions 86a,b may not be mirror images, but the interior surfaces, such as internal portions 81a,b and tapered portions 80a,b would still be substantially similar. However, in yet other embodiments, the two (or more) sidewalls need not be identical, similar, or mirror images.

While tapering the sidewalls 70 as described above can be beneficial for ion wind fans of any size, they are particularly useful when small-scale fans are being implemented. The dimensions for one embodiment of a small-scale fan 58 that satisfies all of the design rules set forth above are 2.0 mm gap between the emitters 64 and the collector 58; 0.9 mm between the plane of the collector 58 and the downstream portion 82; 1.45 mm for the width of the sidewall 70 at the downstream end (length of downstream portion 82); 3.5 mm for the height of the sidewall (length of external portion 86); and 0.18 mm for the width of the sidewall 70 at the upstream end (length of the upstream portion 84). In one embodiment, the angle of taper of the tapered portion 80 is 31.5 degrees, measured from the Z-axis. In other embodiments, other dimensions can be used; the above dimensions are just one example size.

In other embodiments, some limitations on dimensions are given. For example, in one embodiment, the width of the sidewall at the downstream end is at least 1.2 mm and at most 3 mm. In yet other embodiments, the taper is at most 45 degrees, where a linear taper is used. Yet other embodiments have a maximum 5 mm air gap between the emitters 64 and the collector 58.

While the example ion wind fans described and pictured above are shown as having either two or three emitter electrodes, any number of emitter electrodes can be used, including one, to create one or more-channel ion wind fans. While most electronics cooling applications using a wire emitter will have between 1-10 emitter electrodes, the invention is not limited to any range of emitter electrodes used. For example, a pin-grid emitter configuration would likely use 10 s or 100 s of electrodes.

While the embodiments were generally described in the context of positive DC corona applications, the embodiments of the present invention are similarly applicable to negative DC corona, AC corona, or other non-corona ion wind applications without substantial modifications. Furthermore, while the chamfering or tapering of the isolator has described as occurring on the sidewall of the isolator, these inventive aspects of the present invention can be implemented on any portion of any isolation structure of an ion wind fan.

In the descriptions above, various functional modules are given descriptive names, such as “ion wind fan power supply.” The functionality of these modules can be implemented in software, firmware, hardware, or a combination of the above. None of the specific modules or terms—including “power supply” or “ion wind fan” - imply or describe a physical enclosure or separation of the module or component from other system components.

Furthermore, descriptive names such as “emitter electrode,” “collector electrode,” “isolator,” and “sidewall” are merely descriptive and can be implemented in a variety of ways. For example, the “collector electrode,” can be implemented as one piece of metallic structure, but it can also be made of multiple members spaced apart, and connected by wires or other electrical connections to the same voltage potential, such as ground.

Similarly, the isolator can be the substantially frame-like component shown in FIGS. 2-4, but it can have various shapes. The electrodes and the isolator are not limited to any particular material; however, the isolator will generally be made of a dielectric material, such as plastic, ceramic, and other known dielectrics.

The isolator 40 can be made of one piece of injection-molded dielectric, but it can be made up of several pieces attaches together. Furthermore, the various portions of the isolator, such as the collector support, emitter support, and internal sidewall are sometimes defined functionally. For example, since the emitter support and the collector support are adjoining portions of the isolator, it may not be important to spatially define exactly where the boundary between these two portions is.

1. An ion wind fan comprising:
a collector electrode;
a substantially frame-shaped isolator comprising a dielectric and extending around a perimeter of the collector electrode, the isolator comprising a first end portion, a second end portion, and a first sidewall joining the first end portion to the second end portion, the first sidewall comprising an downstream sidewall portion positioned substantially in a first plane, an external sidewall portion positioned substantially in a second plane, and an internal sidewall portion comprising a chamfer portion, the chamfer portion being positioned substantially in a third plane, wherein the third plane is not parallel with either the first plane or the second plane.

2. The ion wind fan of claim 1, wherein the internal sidewall portion is positioned intermediate the downstream and external sidewall portions.

3. The ion wind fan of claim 1, wherein the collector electrode is insert molded into the isolator.

4. The ion wind fan of claim 1, comprising a second sidewall joining the first end portion to the second end portion, the second sidewall comprising an downstream sidewall portion positioned substantially in the first plane, an external sidewall portion positioned substantially parallel to the second plane, and an internal sidewall portion comprising a chamfer portion, the chamfer portion being positioned substantially in a fourth plane, wherein the fourth plane is not parallel with either the first plane or the second plane.

5. The ion wind fan of claim 4, wherein the internal sidewall portion including the chamfer portion of the second sidewall is a mirror image of the internal sidewall portion including the chamfer portion of the first sidewall.

6. The ion wind fan of claim 4, wherein isolator comprises an opening between the first sidewall and the second sidewall and the first end portion and the second end portion, wherein the opening exposes an active portion of collector electrode.

7. The ion wind fan of claim 1, wherein the first, second, and third planes are all perpendicular to a transverse plane of the ion wind fan.

8. The ion wind fan of claim 1, wherein an angle between the second plane and the third plane is between 20 and 40 degrees.

9. The ion wind fan of claim 1, further comprising one or more emitter electrodes.

10. An ion wind fan comprising:
an emitter electrode;
a collector electrode; wherein ion wind is generated by the application of a high voltage potential across the emitter electrode and the collector electrode; and
an isolator comprising a dielectric to provide electrical isolation for one or both of the emitter electrode and the collector electrode, wherein the isolator comprises a sidewall having a tapered shape so that the sidewall becomes thinner in the upstream direction over at least a portion of the sidewall.

11. The ion wind fan of claim 10, wherein the collector electrode is supported at least in part by the sidewall at a portion of the sidewall having first width.

12. The ion wind fan of claim 11, wherein a height of the sidewall extends upstream far enough so that the distance between the upstream edge of the sidewall and the collector electrode is greater than the air gap between the emitter electrode and the collector electrode.

13. The ion wind fan of claim 11, wherein a height of the sidewall extends upstream far enough to provide mechanical protection to the emitter electrode.

14. The ion wind fan of claim 11, wherein the sidewall has a second width at the upstream edge of the sidewall, the second width being less than the first width, wherein the sidewall tapers between the first width and the second width.

15. The ion wind fan of claim 10, wherein the tapered shape comprises a linear taper.

16. The ion wind fan of claim 15, wherein the angle of taper is between 20-45 degrees.

17. The ion wind fan of claim 10, wherein the tapered shape comprises a non-linear taper.

18. The ion wind fan of claim 17, wherein the non-linear taper comprises a parabolic taper.

19. The ion wind fan of claim 10, wherein a surface path along the sidewall from a point nearest the emitter electrode to the collector electrode is at least twice as long as the difference between an air gap between the emitter electrode and the collector electrode and the air gap between the emitter electrode and the sidewall.

20. An ion wind fan comprising:
a wire emitter electrode oriented in the direction of a longitudinal axis of the ion wind fan;
a plane-shaped collector electrode comprising a plurality of air-passage openings, and
an isolator to provide physical support and electrical isolation to the emitter and collector electrodes, the isolator comprising a first sidewall oriented in the direction of the longitudinal axis, the first sidewall having a width in the direction of a transverse axis, the transverse axis being perpendicular to the longitudinal axis, and a height in the direction of an airflow axis, the airflow axis being perpendicular to the longitudinal and transverse axes;
wherein the width of the first sidewall decreases in the upstream direction along the airflow axis to increase the air gap between the sidewall and the emitter electrode.
